(19) United States
(12) Patent Application Publication
(10) Pub. No.: US 2013/0042446 A1
(43) Pub. Date: Feb. 21, 2013

(54) SEGMENT POSITIONING BELT

(71) Applicant: Hsin-Hsiang TSENG, Changhua City (TW)

(72) Inventor: Hsin-Hsiang TSENG, Changhua City (TW)

(73) Assignee: TAIWAN KUO HER INDUSTRIAL CO., LTD., Changhua City (TW)

(21) Appl. No.: 13/212,314

(22) Filed: Aug. 18, 2011

(51) Int. Cl. A44B 19/24; B32B 3/10; B32B 3/30; B32B 15/06; B32B 15/08

(52) U.S. Cl. 24/68 R; 428/465; 428/457; 428/167; 428/137; 428/172

(57) ABSTRACT

An improved structure of a segment positioning belt characterized in that it includes a flexible belt body having the form of an elongated strip. The belt body made of plastic or rubber materials presents flexibility, and also has a positioning end and an extension. The positioning end is provided with a mounting portion. Several segment positioning portions are set at interval onto the belt body along its extension. A strengthened metal core is integrally located into the belt body in an elongated form, so as to cover the positioning end and extension of the belt body. The present invention enables production of tensile stress against breakage of the belt body through arrangement of the strengthened metal core, making it possible to improve the endurance of the segment positioning belt, extend its service life and enhance the safety with better anti-burglary effect.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates generally to a segment positioning belt, and more particularly to an innovative one which is provided with strengthened metal cores.

2. Description of Related Art including Information Disclosed under 37 CFR 1.97 and 37 CFR 1.98.

The segment positioning belt of the present invention is widely applied for tightening/positioning of ski boots or bicycle carriers, etc.

Owing to the inherent flexibility, the segment positioning belt is provided with toothed or perforated segment positioning portions, which are mated with a positioner for the purpose of segment positioning.

In order to realize the flexibility and positioning, the belt body of a segment positioning belt is generally made of plastic or rubber materials. Yet, some problems are encountered in actual applications, such as: structural strength, endurance and safety. As mentioned above, there is a demanding safety requirement for the segment positioning belt since it is often applied for tightening/positioning of ski boots or bicycle carriers, etc. However, the plastic or rubber materials of the conventional segment positioning belt will gradually deteriorate to become fragile, leading to possible cracking or breakage or even safety hazards.

From another perspective, when said segment positioning belt is used for binding/positioning important objects, its plastic or rubber materials make it vulnerable to burglary, bringing about safety issues against theft.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The primary objective of the present invention is to provide an improved structure of segment positioning belt for ideal applications through research and development.

The present invention is characterized in that the segment positioning belt comprises a flexible belt body, formed into an elongated strip. The belt body made of plastic or rubber materials presents flexibility, and comprises a positioning end and an extension, of which the positioning end is provided with a mounting portion. Several segment positioning portions are set at interval onto the belt body along its extension. At least a strengthened metal core is integrally located into the belt body in an elongated form, so as to cover the positioning end and extension of the belt body. The present invention enables production of tensile stress against breakage of the belt body through arrangement of the strengthened metal core, making it possible to improve the endurance of the segment positioning belt, extend its service life and enhance the safety with better anti-burglary effects.

The enhanced efficacy of the present invention is as follows:

Based on the unique structure of the present invention wherein the “improved structure of a segment positioning belt” allows said strengthened metal core to be integrally located into the belt body of the segment positioning belt, the present invention enables production of tensile stress against breakage of the belt body through arrangement of the strengthened metal core, making it possible to improve the endurance of segment positioning belt, extend its service life and enhance the safety with better anti-burglary effects.

The improvements brought about by this invention are as follows:

Based on the structure wherein one end of the strengthened metal core of the belt body is coupled firmly with the looped portion or core tube/core bar, this could further enhance the strength of the mounting portion and strengthened metal core, such that the segment positioning belt can be used due to better endurance, service life, safety and anti-burglary performance.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled perspective view of the preferred embodiment of the segment positioning belt of the present invention.

FIG. 2 is a sectional view of the preferred embodiment of the segment positioning belt of the present invention.

FIG. 3 is an application view of the present invention wherein the segment positioning portion is provided with a tip edge.

FIG. 4 is a schematic view of the present invention wherein the segment positioning portion is provided with a tip edge.

FIG. 5 is a schematic view of the present invention wherein the segment positioning portion has perforated holes.

FIG. 6 is another schematic view of the present invention wherein the segment positioning portion has perforated holes.

FIG. 7 is a schematic view of the present invention wherein the segment positioning belt is used to fix a ski boot.

FIG. 8 is a schematic view of the present invention wherein the segment positioning belt is applied to a bicycle carrier.

FIG. 9 is another schematic view of the positioning and release controller of the present invention.

FIG. 10 is a schematic view of the present invention wherein the looped portion is formed by a looped metal element.

FIG. 11 is a schematic view of the present invention wherein the mounting portion has an expanded bulge.

FIG. 12 is another schematic view of the present invention wherein the mounting portion has an expanded bulge.

### DETAILED DESCRIPTION OF THE INVENTION

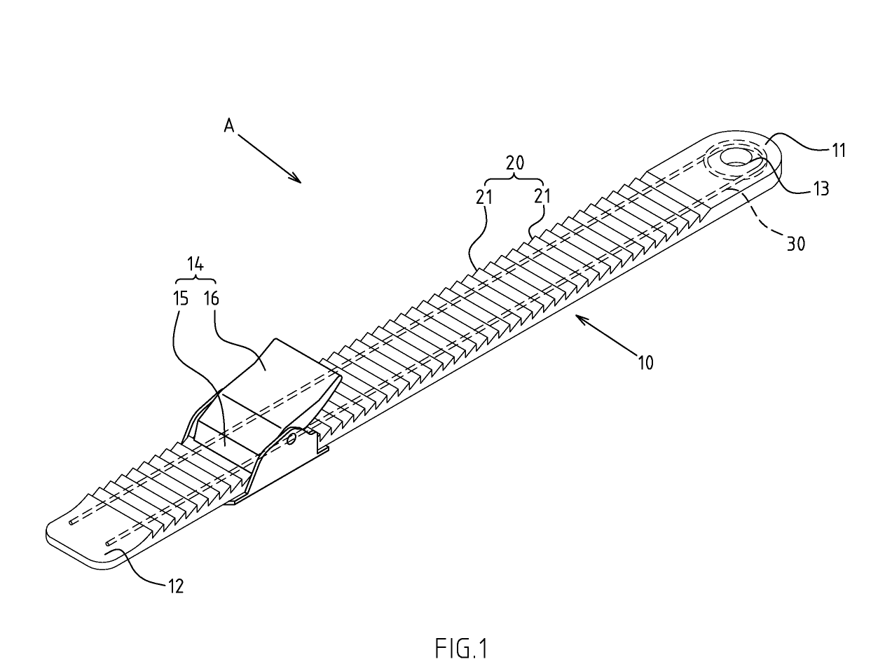

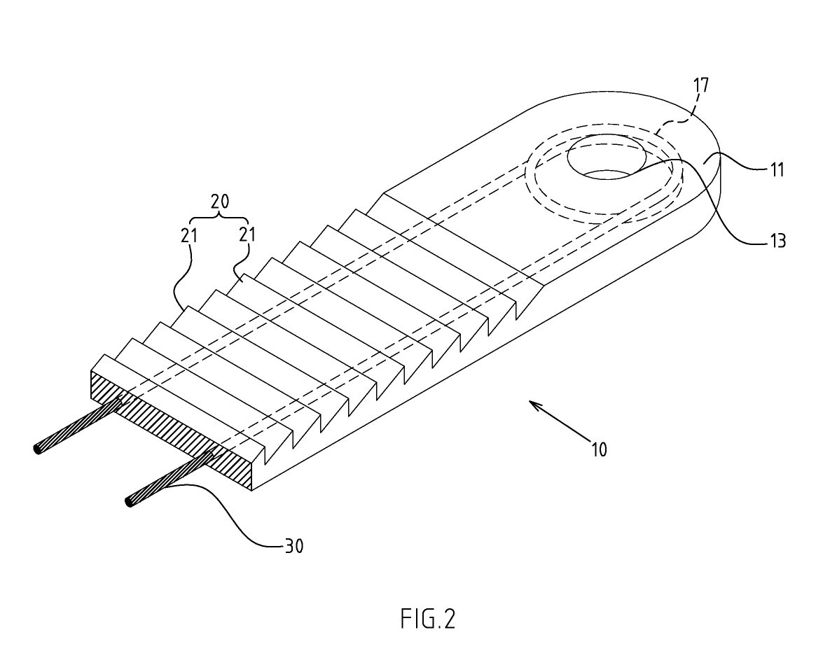

FIGS. 1 and 2 depict preferred embodiments of an improved segment positioning belt of the present invention, which, however, are provided for only explanatory objective for patent claims.

Said segment positioning belt A comprises a flexible belt body 10 configured into an elongated strip. The belt body is made of plastic or rubber materials and presents flexibility, and also comprises a positioning end 11 and an extension 12. The positioning end is provided with a mounting portion 13.

Several segment positioning portions 20 are set at interval onto the belt body 10 along its extension.

At least a strengthened metal core 30 is integrally located into the belt body in an elongated form, so as to cover the positioning end 11 and extension 12 of the belt body 10. The present invention enables production of tensile stress against breakage of the belt body 10. The strengthened metal core 30 is made of steel rope, but not limited to it.

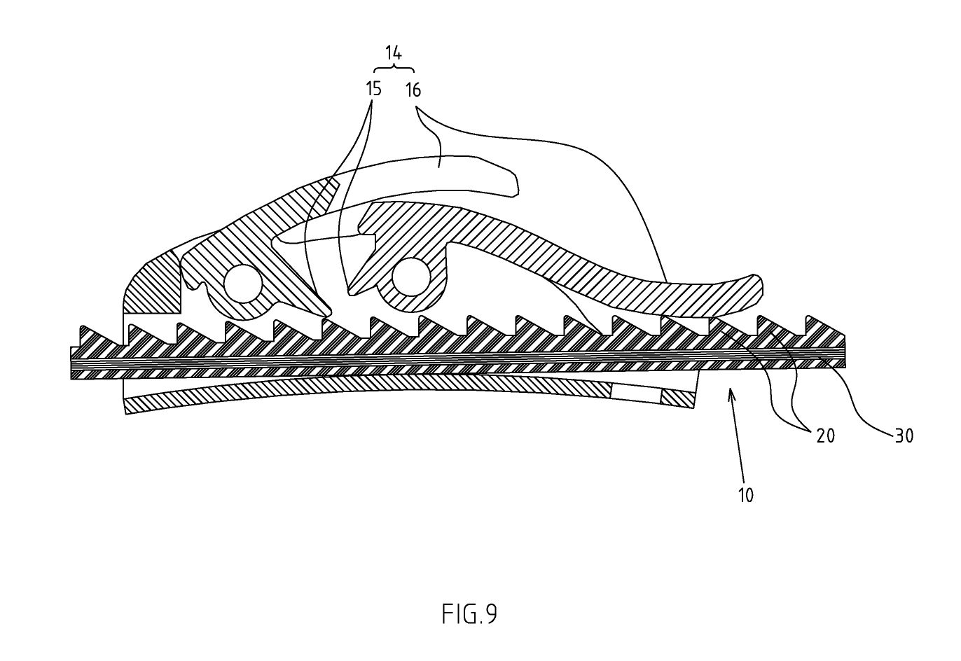

Of which, a positioning and release controller 14 is set at one location of the belt body 10, and comprised of a snapper 15 and a controlling device 16. The snapper 15 could be embedded into any segment positioning portion 20 of the belt body 10 for the positioning purposes. The controlling device 16 is used to control the positioning or release state of the snapper 15. Moreover, the positioning and release controller 14 can also be comprised of two controlling devices 16 and two snappers 15 (shown in FIG. 9) for better embedding effect.

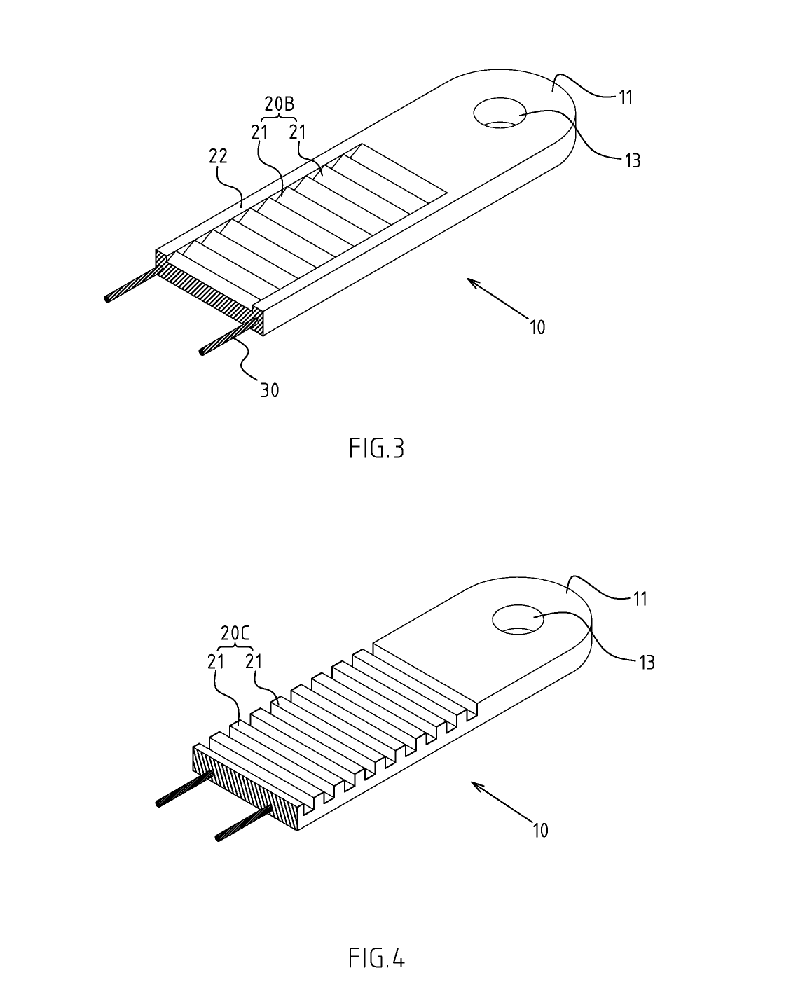

Referring to FIGS. 1 and 2, the segment positioning portion 20 of the belt body 10 has a toothed pattern. As for the toothed segment positioning portion 20, its tip edge 21 is as wide as that of the belt body 10 (shown in FIGS. 1, 2) or recessed into the belt body 10 (shown in FIG. 3). When the tip edge 21 of the segment positioning portion 20B shown in FIG. 3 is recessed into the belt body 10, two flanged portions 22 of bigger thickness are formed at both sides of the tip edge 21, such that the strengthened metal core 30 is set into the flanged portion 22. The cross section of said tip edge 21 has single-bevel triangular teeth (shown in FIG. 2), or the cross section of said tip edge 21 of the segment positioning portion 20C (shown in FIG. 4) is rectangular convex (concave) teeth.

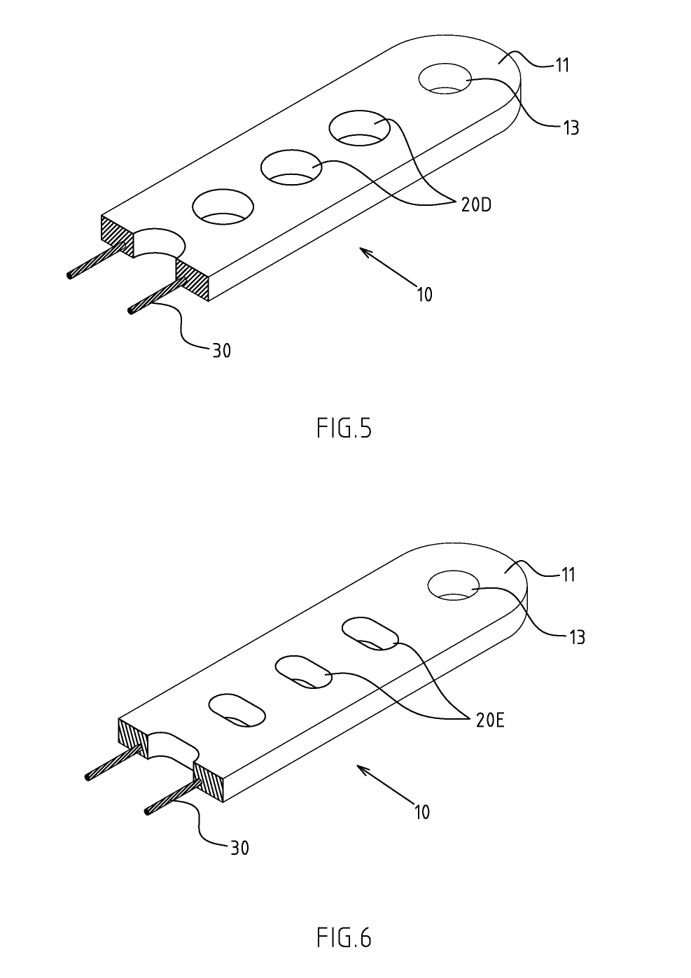

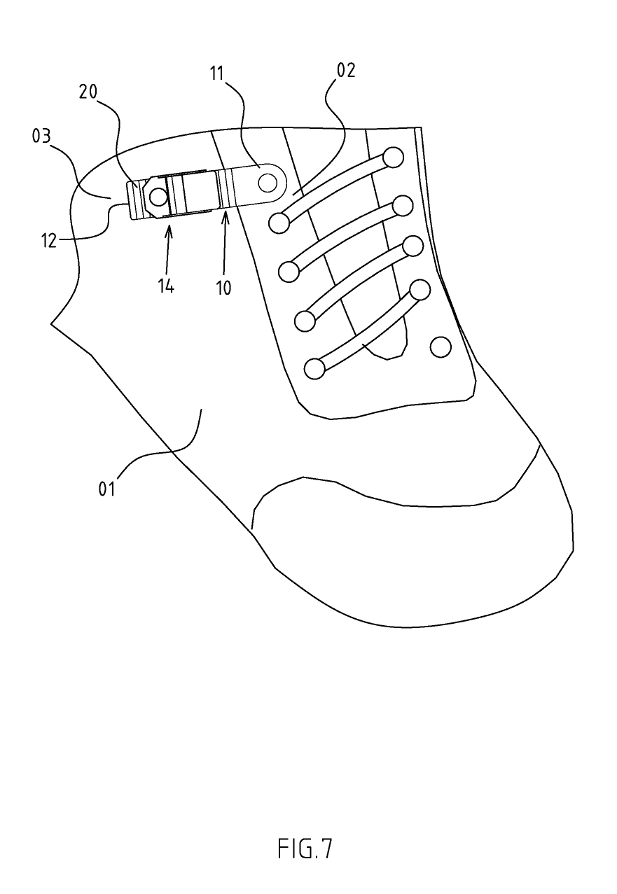

Referring also to FIG. 5, the segment positioning portion 20D has perforated round holes. Referring also to FIG. 6, the segment positioning portion 20E has perforated long holes. The preferred embodiments in FIGS. 3-6 represent the multiple patterns of the segment positioning portion 20 of the belt body 10 in the present invention.

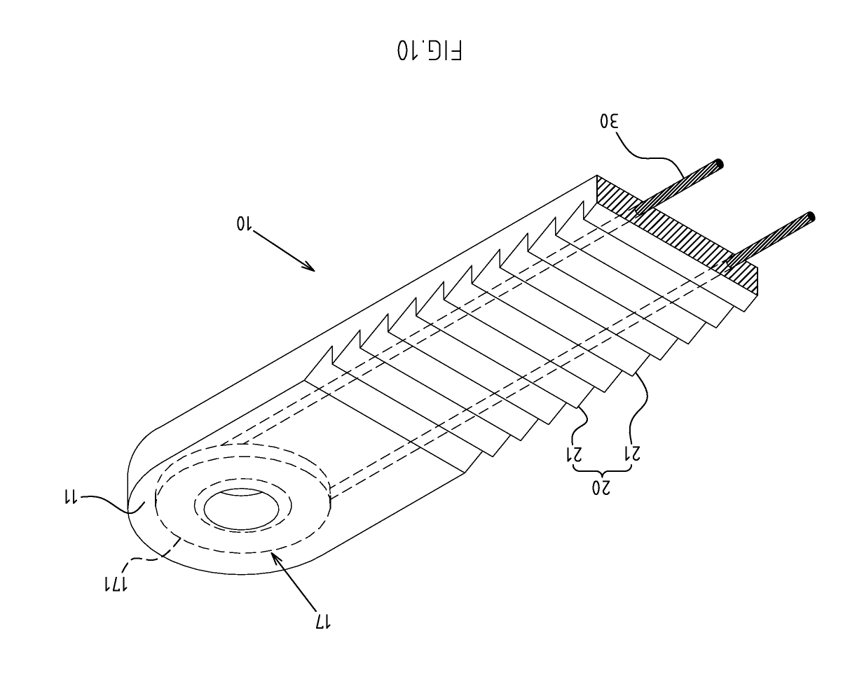

Of which, a looped portion 17 is set onto one end of the strengthened metal core 30 correspondingly to the mounting portion 13 at the positioning end 12 of the belt body 10, such that the mounting portion 13 is surrounded by the looped portion 17. The looped portion 17 could be formed by bending of the strengthened metal core 30 (disclosed in FIG. 2). Referring also to FIG. 10, the looped portion 17 is formed by a looped metal element 171, then one end of the strengthened metal core 30 is connected to or overlapped with the looped metal element 171 (by welding).

Based upon above-specified structure, the present invention is operated as follows:

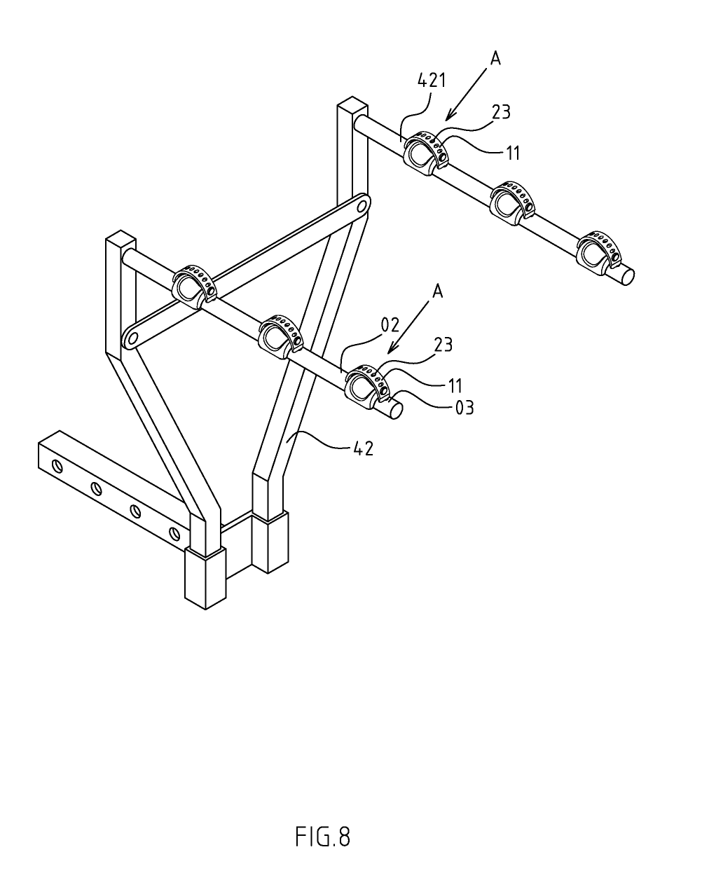

Referring to FIG. 7, the mounting portion 13 at the positioning end 11 of the belt body 10 of the present invention is coupled with the fixed coupling end 02 of the object such as ski boot 01, and the moveable coupling end 03 of the ski boot 01 is coupled with the bottom of the positioning and release controller 14. Next the extension 12 of the belt body 10 passes through the positioning and release controller 14. The segment positioning portion 20 passes through the positioning and release controller 14 in a way that the segment positioning portion 20 and the snapper 15 could be locked firmly. If it is intended to release the tightened belt body 10 from the positioning and release controller 14, users may press the controlling device 16 on the upper end of the positioning and release controller 14 such that the snapper 15 is disengaged from the segment positioning portion 20. Referring also to FIG. 8, another preferred embodiment of the segment positioning belt A, the object hereto is a bicycle carrier 42, which permits the mounting portion 13 of the positioning end 11 to be coupled with its fixed coupling end 421. The segment positioning portion 20 is located by perforation for tightening the bicycle.

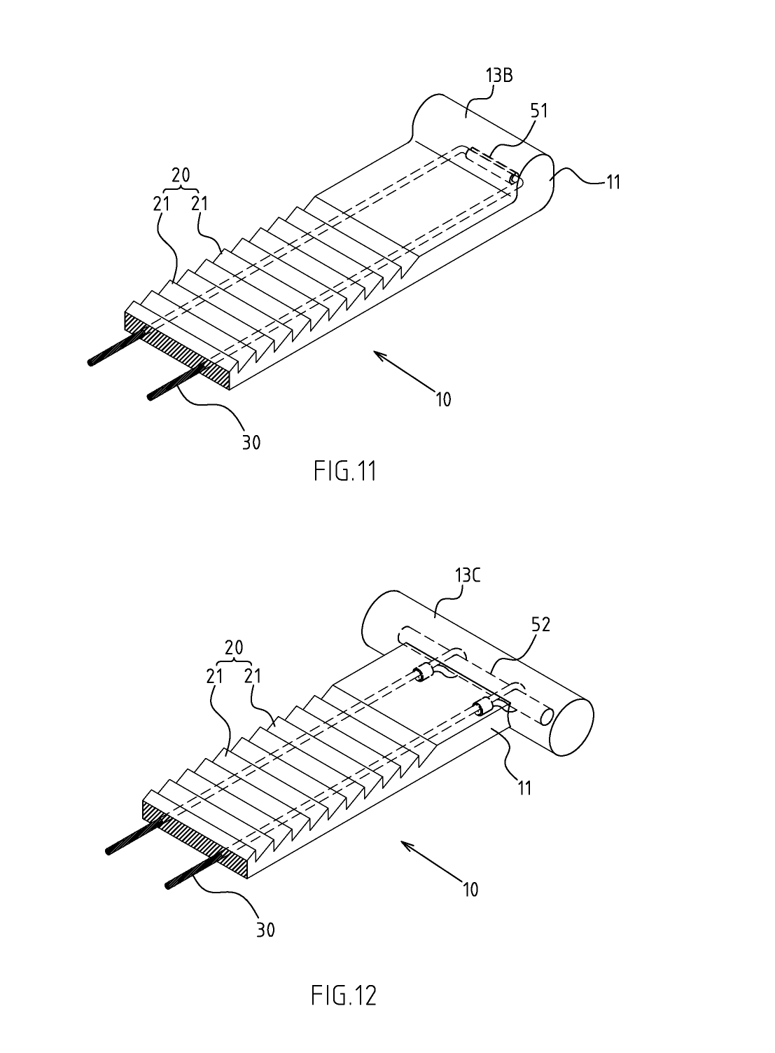

Referring also to FIGS. 11 and 12, the mounting portions 13B, 13C on the positioning end 11 of the belt body 10 have an expanded bulge, into which a core tube 51 or core bar 52 is buried, allowing to connect firmly one end of the strengthened metal core 30, thus further enhancing the positioning state of the strengthened metal core 30.

1. An improved segment positioning belt comprising:
a flexible belt body in the form of an elongated strip; the belt body made of plastic or rubber materials presents flexibility, and also comprises a positioning end and an extension; the positioning end is provided with a mounting portion;
several segment positioning portions, set at interval onto the belt body along its extension;
at least a strengthened metal core, integrally located into the belt body in an elongated form, so as to cover the positioning end and extension of the belt body; the segment positioning belt enables production of tensile stress against breakage of the belt body.

2. The structure defined in claim 1, wherein a positioning and release controller is set at one location of the belt body, and comprised of a snapper and a controlling device; the snapper could be embedded into any segment positioning portion of the belt body for the positioning purpose; the controlling device is used to control the positioning or release state of the snapper.

3. The structure defined in claim 1, wherein the segment positioning portion of the belt body has a toothed pattern; it's a tip edge is as wide as the belt body or recessed into the belt body; when the tip edge of the segment positioning portion is recessed into the belt body, two flanged portions are formed at both sides of the tip edge, such that the strengthened metal core is set into the flanged portion.

4. The structure defined in claim 1, wherein said segment positioning portion has perforated holes.

5. The structure defined in claim 1, wherein the mounting portions on the positioning end of the belt body has perforated holes or an expanded bulge.

6. The structure defined in claim 1, wherein said strengthened metal core set into the belt body is a steel rope.

7. The structure defined in claim 1, wherein said mounting portion on the positioning end of the belt body has a perforated hole; a looped portion is set onto one end of the strengthened metal core correspondingly to the mounting portion at the positioning end of the belt body, such that the mounting portion is surrounded by the looped portion.

8. The structure defined in claim 7, wherein the looped portion could be formed by bending of the strengthened metal core; or, the looped portion is formed by a looped metal element, and then one end of the strengthened metal core is connected to the looped metal element.

9. The structure defined in claim 1, wherein the mounting portions on the positioning end of the belt body have an expanded bulge, into which a core tube or core bar is buried, allowing to connect firmly to one end of the strengthened metal core.
